(19) United States
(12) Patent Application Publication
(10) Pub. No.: US 2006/0271804 A1
(43) Pub. Date: Nov. 30, 2006

(54) Power consumption control for information handling system

(76) Inventors: Joshua N. Alperin, Austin, TX (US); Susan A. Nunn, Austin, TX (US)

Correspondence Address: HAMILTON & TERRILE, LLP, P.O. BOX 203518, AUSTIN, TX, 78720, US

(21) Appl. No.: 11/140,813

(22) Filed: May 31, 2005

(51) Int. Cl. G06F 1/26

(52) U.S. Cl. 713/320

(57) ABSTRACT

The present invention provides a system and method for controlling delivery of electrical power to a circuit board in an information handling system. A power management system is operable to detect an expansion circuit board that is operably coupled to a main system board of an information handling system. The power management subsystem detects the status of a cooling system associated with the expansion circuit board and is operable to control the amount of power delivered to the expansion circuit board based on the status of the cooling system.

### BACKGROUND OF THE INVENTION

1. Field of the Invention

The present invention relates to the field of information handling systems and, more particularly, to a method and system for controlling delivery of electrical power to circuit board components in an information handling system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling system users often upgrade their systems by installing circuit boards in industry standard expansion slots. Some peripheral devices, such as those installed in PCI-Express expansion slots are capable of drawing in excess of 150 watts of power from a computer system. With a significant amount of this energy being dissipated into heat, it is possible to exceed the overall thermal design of the information handling system. It is apparent, therefore, that there is a need for an improved method and system for detecting circuit boards installed in information handling systems and for controlling the amount of power delivered to such expansion boards.

### SUMMARY OF THE INVENTION

In accordance with the present invention, a system and method is provided for controlling delivery of electrical power to a circuit board in an information handling system. In the present invention, a power management system is operable to detect a circuit board that is operably coupled to a main system board of an information handling system. In some embodiments of the invention, the expansion circuit board is operably coupled to the main system board by a connector complying with the PCI-Express operating parameters. The power management subsystem detects the status of a cooling system associated with the expansion circuit board and is operable to control the amount of power delivered to the expansion circuit board based on the status of the cooling system. In some embodiments of the invention, the expansion circuit board is operable to provide information regarding the desired power consumption of the expansion circuit board. The power management subsystem of the present invention is operable to receive the information regarding the desired power consumption of the expansion circuit board and is further operable to detect the status of the cooling system associated with the expansion circuit board. Based on the status of the cooling system associated with the expansion circuit board, the power management subsystem sets the allowed power consumption for the expansion circuit board at an appropriate level.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system in accordance with the present invention.

FIG. 2 is a general illustration of a circuit board comprising a plurality of expansion slots for receiving circuit boards to expand the capabilities of an information handling system.

FIG. 3 is a flow diagram of the processing steps implemented by an information handling system to determine the power consumed by an expansion circuit board in accordance with the present invention.

### DETAILED DESCRIPTION

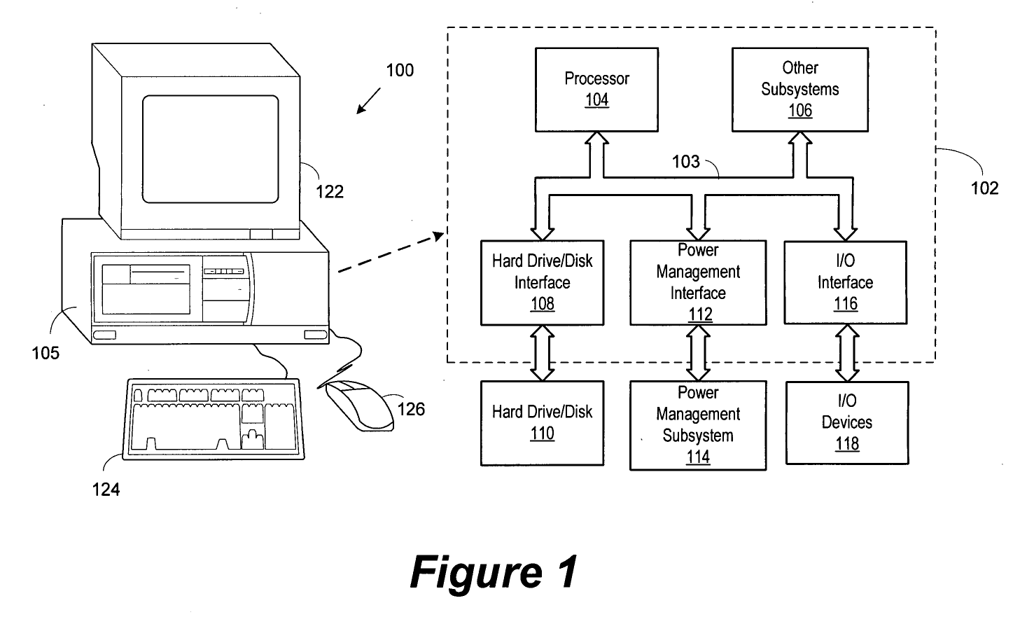

The method and apparatus of the present invention provides significant improvements in the use of circuit boards for expanding the performance capabilities of an information handling system, such as the information handling system 100 shown in FIG. 1. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices, as well as various input and output (I/O) devices, such as a keyboard, a mouse, and a video display. The information handling system may also include one or more buses operable to transmit communications between the various hardware components.

Referring to FIG. 1, the information handling system 100 includes a main system board 102 that comprises a processor 104 and various other subsystems 106 understood by those skilled in the art. Data is transferred between the various system components via various data buses illustrated generally by bus 103. A hard drive 110 is controlled by a hard drive/disk interface 108 that is operably connected to the hard drive/disk 110. An input/output (I/O) interface 116 controls the transfer of data between the various system components and a plurality of input/output (I/O) devices 118, such as a display 122, a keyboard 124, and a mouse 126. A power management interface 112 is operable to control a power management subsystem 114 that monitors and manages power consumption with system components, as discussed in greater detail hereinbelow. The main system board 102 and associated components are mounted in a housing 105 that may include one or more fans for cooling the system components as discussed hereinbelow.

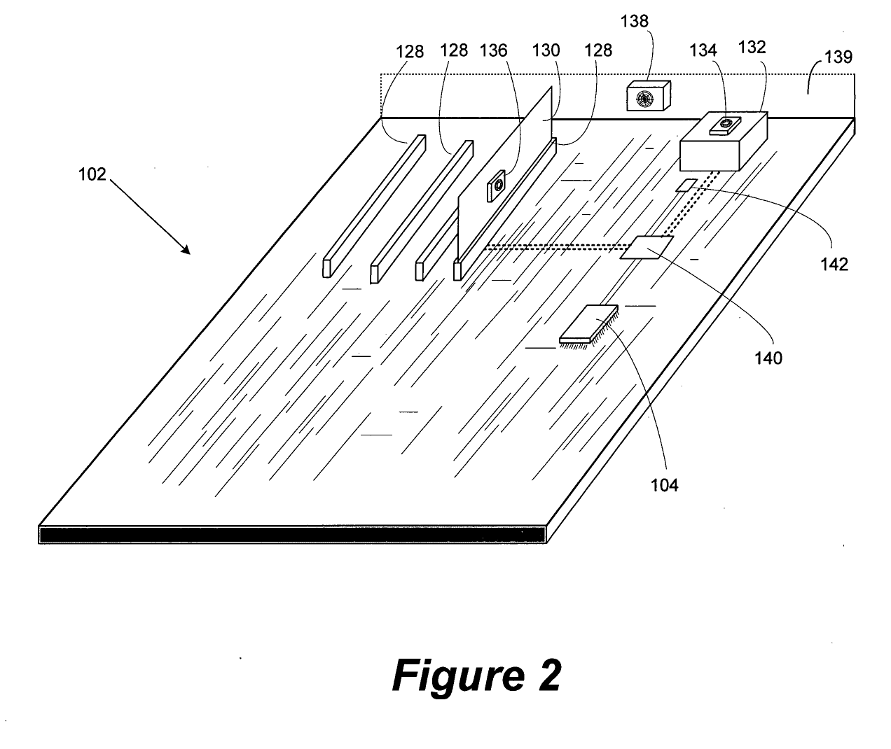

FIG. 2 is a generalized illustration of a printed circuit board such as the main system board (or motherboard) 102 discussed above in connection with FIG. 1. The circuit board 102 comprises a plurality of expansion card slots 128 that can connect expansion circuit boards, such as circuit board 130, to enhance the functionality of the information handling system. As will be understood by those of skill in the art, the expansion slots communicate with the other system components over a bus that conforms to one of several industry-standard protocols, such as ISA, AGP, PCI or PCI-Express. A power supply 132 provides power for the active components on the motherboard 102 and for the circuit boards that are connected to the expansion slots. A cooling system 134, associated with the power supply, is operable to transport heat from the power supply 132. A cooling system 136 transports heat away from the expansion circuit board 130. Finally, a cooling system 138, which may be mounted on the chassis 139 or housing 105 of the information handling system, transports heat from the interior of the case to maintain all of the system components at an acceptable temperature. The various cooling systems discussed hereinabove may consist of electric fans or may comprise combinations of active and passive cooling devices known to those of skill in the art.

As will be discussed in greater detail hereinbelow, the present invention provides a method and system for detecting the expansion circuit board 130 and for controlling the power consumption of the expansion circuit board 130 based on a plurality of operating parameters that may include the state of the cooling system 136 associated with the expansion circuit board 130 and the temperature of other components in the information handling system 100. The power management subsystem is embodied in an integrated circuit 140 that is operably coupled to the processor 104 and is operable to receive and execute control signals received therefrom.

As was discussed hereinabove, one of the embodiments of the present invention implements the power management control using PCI-Express protocols in accordance with the PCI-Express Base Specification Revision 1.0, published on Jul. 22, 2002 (the “PCI-Express Specification”). In particular, page 389 of the aforementioned document describes the “Cards Power Budgeting structure” and the Power Budgeting Enhanced Capability Header (ID=0004) using the Data Select Register and the Data Register. In addition, page 352 of the aforementioned document describes the “PCI Express x16 slot power limit” in connection with the PCI Express Capability List Register (ID=10h) offset 14h (Slot Capability Register) Bit[14:7]=slot power limit value, Bit[16:15]=slot power limit scale. Each of the aforementioned portions of PCI-Express Specification is hereby incorporated by reference for all purposes. The PCI registers and related data parameters discussed above can be used to implement the power management functions described herein using circuitry and programming techniques known to those of skill in the art.

Referring again to FIG. 2, a power management subsystem integrated circuit 140 is operably coupled to the processor 104 and is operable to execute instructions generated by the processor. The power management subsystem 140 also receives information from a temperature monitor 142 that can be placed on the main system board 102 or elsewhere within the information handling system housing 105. The power management subsystem 140 receives information from the expansion circuit board 130 which may include the desired power consumption of the circuit board 130. The power management subsystem is operable to monitor and control the cooling system 136 associated with the expansion circuit board 130.

The power management subsystem 140 is operably connected to the power supply 132 and can control the amount of electrical power delivered by the power supply 132 depending on the desired power consumption for the expansion circuit board 130 and the status of the cooling system associated with the expansion circuit board 130. The power management subsystem is operable to monitor and control the cooling system 134 associated with the power supply 132. Finally, the power management subsystem 140 is operable to monitor and control the cooling system 138 on the information handling system chassis 139 to maintain the interior temperature of the information handling system at a predetermined temperature.

With regard to the energy consumption and cooling parameters of the expansion circuit board 130, the power management subsystem 140 is capable of receiving information regarding the existence of cooling system 136, the operating condition of cooling system 136, or the lack of a cooling system on the circuit board 130. The power management subsystem is also capable of monitoring the operating condition of the cooling systems 134 and 138. In one embodiment of the invention, the amount of power delivered to the expansion circuit board 130 is determined by monitoring the existence of the cooling system 136 and its operating status. In other embodiments of the invention, the amount of power delivered to the expansion circuit board is controlled by monitoring and controlling the operating status of the cooling systems 134 and 138, either individually or in combination.

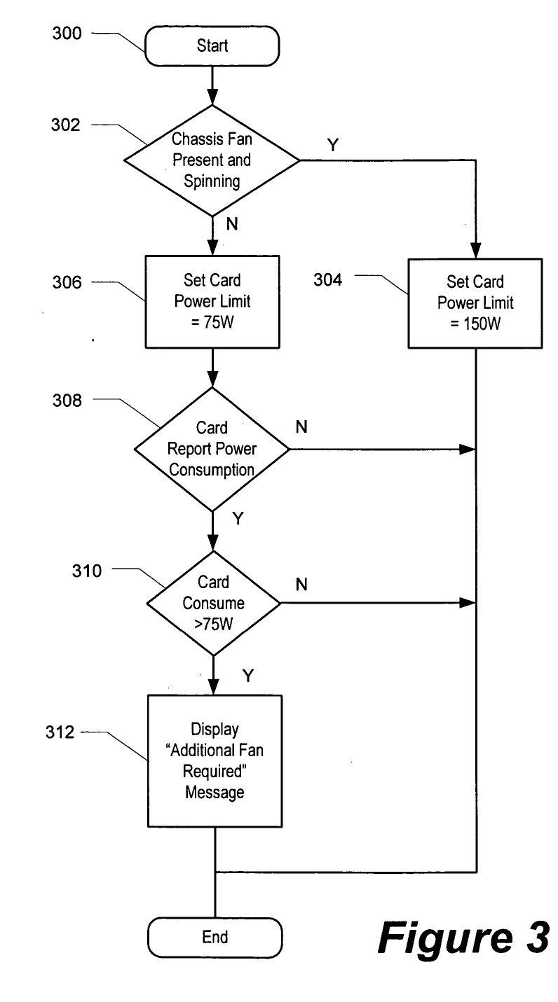

FIG. 3 is a flow diagram of the processing steps implemented by the power management subsystem to control the power consumed by the expansion board 130 in accordance with the present invention. In step 302, the power management subsystem starts its monitoring function, and in step 302 determines whether the chassis fan is present and operating correctly. If the result of the test conducted in step 302 indicates that the chassis fan is present and spinning, processing proceeds to step 304 where the power limit for the expansion card is set at 150 watts. If, however, the result of the test conducted in step 302 indicates that the chassis fan is not present, or that the chassis fan is not spinning, processing proceeds to step 304 where the power limit for the expansion card 130 is set at 75 watts. In step 308, a test is conducted to determine whether the expansion circuit board 130 is reporting its desired power consumption. If the result of the test conducted in step 308 indicates that the card is reporting power consumption, processing proceeds to step 310 where a test is conducted to determine whether the card is designed to consume more than 75 watts. If, however, the test conducted in step 310 indicates that the card is not intended to consume more than 75 watts, the power management processing sequence is ended and the power delivered to the card is set at 75 watts. If the result of the test conducted in step 310 indicates that the card is designed to consume more than 75 watts (but the cooling system is inoperable or not present), processing proceeds to step 312 where a message is displayed on the system monitor indicating that “additional cooling fan required.” While the power management techniques discussed hereinabove have been described with respect to two specific power levels, i.e., 75W and 150W, it will be apparent to those of skill in the art that the present invention can be implemented using a plurality of other power levels for the expansion circuit board 130.

Although the present invention has been described in detail, it should be understood that various changes, substitutions and alterations can be made hereto without departing from the spirit and scope of the invention as defined by the appended claims.

What is claimed is:

1. A method for managing power utilization in an information handling system, the method comprising:
detecting an expansion circuit board operably coupled to a main system board in said information handling system;
receiving information relating to the power consumption of said expansion circuit board;
detecting the status of a cooling system associated with said expansion circuit board; and
controlling the power consumption of said expansion circuit board based on the status of said cooling system.

2. The method of claim 1, wherein said cooling system is mounted on said expansion circuit board.

3. The method of claim 1, wherein said cooling system is mounted on a housing containing said information handling system.

4. The method of claim 1, wherein said expansion circuit board is coupled to said main system board by a connection complying with the PCI-Express parameters.

5. The method of claim 4, wherein said expansion circuit board is operable to provide information regarding power consumption to a power management subsystem of said information handling system.

6. The method of claim 4, wherein said power consumption is set to a first state upon detecting that said cooling system is operating.

7. The method of claim 6, wherein said power consumption is set to a second state upon detecting that said cooling system is not operating.

8. The method of claim 7, wherein said second state of power consumption is lower than said first state.

9. An information handling system comprising:
a central processing unit operable to process information;
a main system circuit board comprising at least one connector for coupling said main system circuit board to an expansion circuit board;
an expansion circuit board operably connected to said information handling system by said connector; and
a power management system operable to:
detect said expansion circuit board coupled to a main system board in said information handling system;
receive information from said expansion circuit board regarding the power consumption of said expansion circuit board; and
detect the status of a cooling system associated with said expansion circuit board;
wherein said power management subsystem controls the power consumption of said expansion circuit board based on the status of said cooling system.

10. The information handling system of claim 9, wherein said cooling system is mounted on said expansion circuit board.

11. The information handling system of claim 9, wherein said cooling system is mounted on a housing containing said information handling system.

12. The information handling system of claim 9, wherein said expansion circuit board is coupled to said main system board by a connection complying with the PCI-Express parameters.

13. The information handling system of claim 12, wherein said expansion circuit board is operable to provide information regarding power consumption to a power management subsystem of said information handling system.

14. The information handling system of claim 12, wherein said power consumption is set to a first state upon detecting that said cooling system is operating.

15. The information handling system of claim 14, wherein said power consumption is set to a second state upon detecting that said cooling system is not operating.

16. The information handling system of claim 15, wherein said second state of power consumption is lower than said first state.

17. A system for managing power utilization in an information handling system, the method comprising:
means for detecting an expansion circuit board operably coupled to a main system board in said information handling system;
means for receiving information relating to the power consumption of said expansion circuit board;
means for detecting the status of a cooling system associated with said expansion circuit board; and
means for controlling the power consumption of said expansion circuit board based on the status of said cooling system.

17. The system of claim 16, wherein said expansion circuit board is coupled to said main system board by a connection complying with the PCI-Express parameters.

18. The system of claim 17, wherein said power consumption is set to a first state upon detecting that said cooling system is operating.

19. The system of claim 18, wherein said power consumption is set to a second state upon detecting that said cooling system is not operating.

20. The system of claim 19, wherein said second state of power consumption is lower than said first state.
